(19) United States
(12) Patent Application Publication
(10) Pub. No.: US 2025/0207694 A1
(43) Pub. Date: Jun. 26, 2025

(54) FUEL TRANSPORTATION HOSE

(71) Applicant: THE YOKOHAMA RUBBER CO., LTD., Kanagawa (JP)

(72) Inventors: Ai MOMOSE, Kanagawa (JP); Shun SATO, Kanagawa (JP)

(21) Appl. No.: 18/850,899

(22) PCT Filed: Dec. 16, 2022
(86) PCT No.: PCT/JP2022/046485

§ 371 Date: Sep. 25, 2024

(30) Foreign Application Priority Data
Mar. 31, 2022 (JP) 2022-059406

(51) Int. Cl. F16L 11/08; F16L 11/12

(52) U.S. Cl. CPC F16L 11/08; F16L 11/12

(57) ABSTRACT

A fuel transportation hose of an embodiment of the present technology includes an inner layer, an intermediate layer, a reinforcing layer, and an outer layer laminated in this order. The inner layer contains a thermoplastic resin composition containing first thermoplastic resin having a deflection temperature under load of 75° C. or higher and second thermoplastic resin having a deflection temperature under load of lower than 75° C. The intermediate layer contains a rubber composition containing nitrile rubber. The inner layer and the intermediate layer are bonded in a direct manner or via an adhesive layer.

### TECHNICAL FIELD

The present disclosure relates to a fuel transportation hose. The present disclosure relates particularly to a transportation hose for fuel such as gasoline, light oil, kerosene, and liquefied petroleum gas.

### BACKGROUND ART

The hose for transporting fuel or the like may have a layer of vulcanized rubber on an inner side.

Japan Unexamined Patent Publication No. 2004-176908 A describes a hose having low gas permeability including an inner side layer, a reinforcing layer, and an outer side layer. The inner side layer includes a waterproof layer that is an innermost layer made of vulcanized rubber, and a gas barrier layer made on an outer surface side of the waterproof layer.

### SUMMARY

A fuel transportation hose is provided that can reduce interlayer detachment of the hose while reducing elution of sulfur to a transported object.

The present technology may include the following features.

### Aspect 1

A fuel transportation hose including an inner layer, an intermediate layer, a reinforcing layer, and an outer layer laminated in this order,
the inner layer contains a thermoplastic resin composition containing first thermoplastic resin having a deflection temperature under load of 75° C. or higher and second thermoplastic resin having a deflection temperature under load of lower than 75° C.,
the intermediate layer contains a rubber composition containing acrylonitrile-butadiene rubber, and
the inner layer and the intermediate layer are bonded in a direct manner or via an adhesive layer.

### Aspect 2

The fuel transportation hose according to Aspect 1, wherein a mass ratio of the first thermoplastic resin to a total of the first thermoplastic resin and the second thermoplastic resin is from 0.05 to 0.95.

### Aspect 3

The fuel transportation hose according to Aspect 1 or 2, wherein the first thermoplastic resin has an aromatic ring in a main chain.

### Aspect 4

The fuel transportation hose according to Aspect 3, wherein the aromatic ring has 6 to 10 carbons.

### Aspect 5

The fuel transportation hose according to any one of Aspects 1 to 4, wherein the first thermoplastic resin is aromatic polyamide resin.

### Aspect 6

The fuel transportation hose according to any one of Aspects 1 to 5, wherein the second thermoplastic resin is aliphatic polyamide.

### Aspect 7

The fuel transportation hose according to any one of Aspects 1 to 6, wherein the inner layer has a content of a free sulfur component with respect to an amount of the inner layer of 1.0 mass % or less or contains no free sulfur component.

### Aspect 8

The fuel transportation hose according to any one of Aspects 1 to 7, wherein a ratio of a thickness of the inner layer to a thickness of the intermediate layer is from 0.01 to 2.00.

### Aspect 9

The fuel transportation hose according to any one of Aspects 1 to 8, wherein
the inner layer has a degree of swelling after 7 days of immersion in a fuel at a temperature of 23° C. of 35.0% or less, and
the fuel contains 42.5 vol % of isooctane, 42.5 vol % of toluene, and 15 vol % of ethanol with respect to an entire amount of the fuel.

### Aspect 10

The fuel transportation hose according to any one of Aspects 1 to 9, wherein
the inner layer has a fuel transmission after 7 days of immersion in a fuel at a temperature of 23° C. of 5.00 mg·mm/24 h·cm² or less, and
the fuel contains 42.5 vol % of isooctane, 42.5 vol % of toluene, and 15 vol % of ethanol with respect to an entire amount of the fuel.

### Aspect 11

The fuel transportation hose according to any one of Aspects 1 to 10, wherein the inner layer has a storage modulus E at −30° C. of 1500 to 3500 MPa.

### Aspect 12

The fuel transportation hose according to any one of Aspects 1 to 11, wherein the inner layer further contains rubber and/or elastomer.

### Aspect 13

The fuel transportation hose according to Aspect 12, wherein the elastomer is polyester elastomer, polyamide elastomer, or modified styrene-based elastomer.

### Aspect 14

The fuel transportation hose according to Aspect 12 or 13, wherein the inner layer has a sea-island structure of the thermoplastic resin composition and the rubber and/or the elastomer.

### Aspect 15

The fuel transportation hose according to any one of Aspects 1 to 14, wherein the acrylonitrile-butadiene rubber contained in the intermediate layer contains 25 to 50 mass % of acrylonitrile with respect to an amount of the acrylonitrile-butadiene rubber.

An embodiment of the present technology can provide a fuel transportation hose that can reduce interlayer detachment of the hose while reducing elution of sulfur to a transported object.

### BRIEF DESCRIPTION OF DRAWINGS

FIG. 1 is a schematic diagram of a fuel transportation hose 10 according to a first embodiment of the present technology viewed from a side surface.

FIG. 2 is a schematic diagram illustrating a cross-section of a fuel transportation hose 10 according to a first embodiment of the present technology.

### DETAILED DESCRIPTION

An embodiment of the present disclosure is described in detail below. The present disclosure is not limited to the embodiment described below and can be performed with various modifications within the scope of the present disclosure.

The fuel transportation hose of an embodiment of the present technology is a fuel transportation hose including an inner layer, an intermediate layer, a reinforcing layer, and an outer layer laminated in this order, the inner layer containing a thermoplastic resin composition containing first thermoplastic resin having a deflection temperature under load of 75° C. or higher and second thermoplastic resin having a deflection temperature under load of lower than 75° C., the intermediate layer containing a rubber composition containing vulcanized rubber, and the inner layer and the intermediate layer being bonded in a direct manner or via an adhesive layer.

Here, “an inner layer, an intermediate layer, a reinforcing layer, and an outer layer laminated in this order” means that these layers are laminated in this order from the inner side to the outer side of the fuel transportation hose.

In general, a layer containing a vulcanized rubber composition is employed as a layer on an inner side of a fuel transportation hose. In a case where a transported object, such as a fuel, is transported by using the fuel transportation hose, some of sulfur or a sulfur compound added to the rubber composition may elute to the transported object. From the perspective of reducing such elution of the sulfur component, disposing of an inner layer containing a thermoplastic resin composition as a barrier layer on the innermost side of the fuel transportation hose is considered. It is conceived that, for adhesion between the inner layer and a layer containing a rubber composition, i.e., an intermediate layer, adhesive strength increases due to contact or tangling of the thermoplastic resin composition and the rubber composition at an interface caused by softening or flowing of the thermoplastic resin composition and the rubber composition due to heat during vulcanization; however, softening or flowing is difficult depending on the composition of the thermoplastic resin composition, and the adhesiveness may become insufficient. When repeated or large deformation is applied to such a fuel transportation hose having insufficient adhesiveness, delamination occurs in between the inner layer and the intermediate layer. Depending on the composition of the thermoplastic resin composition, problems of uneven thickness of the inner layer may occur due to flowing or deformation of the rubber composition caused by significant softening or flowing during vulcanization.

It is conceived that, but not limited to the theory, in a case where a deflection temperature under load of a thermoplastic resin composition is large, when repeated or large deformation is applied to a hose after vulcanization, separation tends to occur between an inner layer and an intermediate layer. On the other hand, in a case where a deflection temperature under load of a thermoplastic resin composition is small, it is conceived that the thickness of an inner layer tends to be uneven due to deformation of the inner layer because the inner layer follows deformation of an intermediate layer when a rubber composition is vulcanized.

Because the inner layer of the fuel transportation hose of an embodiment of the present technology contains a thermoplastic resin composition containing first thermoplastic resin having a deflection temperature under load of 75° C. or higher and second thermoplastic resin having a deflection temperature under load of lower than 75° C., even when the rubber composition is vulcanized, the thickness of the inner layer is less likely to change, and excellent adhesiveness between the inner layer and the intermediate layer is achieved.

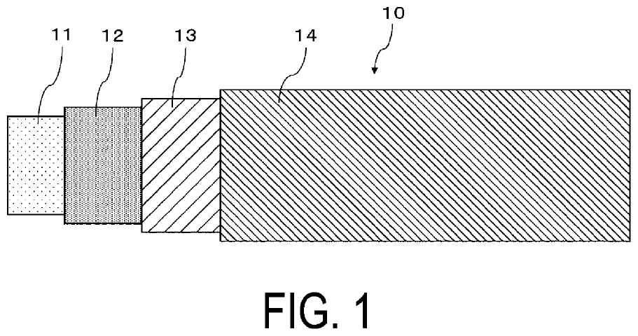

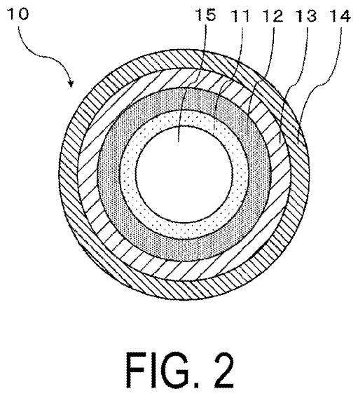

FIGS. 1 and 2 are schematic diagrams illustrating a fuel transportation hose 10 according to a first embodiment of the present technology. Here, FIG. 1 is a diagram of a fuel transportation hose 10 according to a first embodiment of the present technology viewed from a side surface, and FIG. 2 is a cross-sectional view of the fuel transportation hose 10 according to the first embodiment of the present technology in a radial direction. Both FIGS. 1 and 2 do not limit the present technology.

As illustrated in FIGS. 1 and 2, the fuel transportation hose 10 according to the first embodiment of the present technology is a fuel transportation hose 10 including an inner layer 11, an intermediate layer 12, a reinforcing layer 13, and an outer layer 14 laminated in this order. Here, “laminated in this order” means that the layers are laminated in this order from the inner side of the fuel transportation hose 10, i.e., a hose inner portion 15, to the outer side of the fuel transportation hose 10.

The inner layer 11 contains a thermoplastic resin composition containing first thermoplastic resin having a deflection temperature under load of 75° C. or higher and second thermoplastic resin having a deflection temperature under load of lower than 75° C. The intermediate layer 12 contains a rubber composition containing vulcanized rubber. The inner layer 11 and the intermediate layer 12 are bonded in a direct manner or via an adhesive layer (not illustrated).

### Inner Layer

The inner layer contains a thermoplastic resin composition and optionally an additional component such as a flexible component.

Because the inner layer containing the thermoplastic resin composition is disposed on the radially inner side than the intermediate layer containing the vulcanized rubber composition in the fuel transportation hose, elution of a sulfur component from the intermediate layer to a transported object, such as a fuel, can be reduced.

The inner layer preferably has a content of a free sulfur component with respect to the inner layer of 1.0 mass % or less or contains no free sulfur component.

This is because a smaller content of the free sulfur component contained in the inner layer can further reduce elution of a sulfur component to a transported object such as a fuel. Thus, a smaller content of the free sulfur component contained in the inner layer is preferred.

The inner layer can contain a small amount of a free sulfur component by transfer of sulfur or a sulfur compound from the adjacent intermediate layer or adhesive layer and can contain preferably 1.0 mass % or less, more preferably 0.5 mass % or less, and even more preferably 0.2 mass % or less, of the free sulfur component.

Here, “free sulfur component” means sulfur or a sulfur component that can be extracted from an inner layer by a fuel. The content of the free sulfur component contained in the inner layer can be determined by enclosing a test fuel in an inner portion of a hose cut into a predetermined length, allowing this to stand still in an atmosphere at 23° C. for 48 hours or longer, and then quantifying a sulfur component contained in the test fuel. The sulfur component in the test fuel can be detected by, for example, oxidation decomposition coulometric titration by using a commercially available sulfur analyzer in accordance with JIS (Japanese Industrial Standard) K 2541-2 “Crude oil and petroleum products-Determination of sulfur content Part 2: Oxidative microcoulometry”. The test fuel means a fuel containing 42.5 vol % of isooctane, 42.5 vol % of toluene, and 15 vol % of ethanol, with respect to an entire amount of the fuel.

The ratio of the thickness of the inner layer to the thickness of the intermediate layer is preferably from 0.01 to 2.00.

When the ratio of the thickness of the inner layer to the thickness of the intermediate layer is in the range described above, fluctuation of thickness of the inner layer accompanying the flow of the rubber composition of the intermediate layer during vulcanization and adhesiveness to the intermediate layer can be particularly provided in a compatible manner.

The ratio of the thickness of the inner layer to the thickness of the intermediate layer may be from 0.01 to 2.00, from 0.10 to 1.80, or from 0.50 to 1.40.

The inner layer preferably has a degree of swelling after 7 days of immersion in a fuel at a temperature of 23° C. of 35.0% or less.

A degree of swelling of the inner layer smaller than the value described above can further reduce deformation of the inner layer when a fuel is transported by the fuel transportation hose.

The degree of swelling described above may be from 35.0 to 0.0%, from 30.0 to 1.0%, or from 15.0 to 2.0%.

The inner layer preferably has a fuel transmission after 7 days of immersion in a fuel at a temperature of 23° C. of 5.00 mg·mm/24 h·cm² or less.

A fuel transmission of the inner layer smaller than the value described above is more advantageous for transportation of a fuel.

The fuel transmission described above may be from 5.00 to 0.01 mg·mm/24 h·cm², from 4.50 to 0.02 mg·mm/24 h·cm², from 3.50 to 0.10 mg·mm/24 h·cm², or from 2.50 to 0.50 mg·mm/24 h·cm².

The fuel used in measurement of the degree of swelling and the fuel transmission of an embodiment of the present technology is a fuel containing 42.5 vol % of isooctane, 42.5 vol % of toluene, and 15 vol % of ethanol, with respect to an entire amount of the fuel. The fuel that can be transported by the fuel transportation hose of an embodiment of the present technology is not limited to a hose having the composition described above.

The inner layer preferably has a storage modulus E at −30° C. of 1500 to 3500 MPa.

A storage modulus E′ at −30° C. is in the range described above is advantageous for use of the fuel transportation hose at a low-temperature environment.

The storage modulus E′ described above may be from 1500 to 3500 MPa, from 1700 to 3200 MPa, from 2000 to 3000 MPa, or from 2200 to 2500 MPa.

### Thermoplastic Resin Composition

The thermoplastic resin composition contains first thermoplastic resin having a deflection temperature under load of 75° C. or higher and second thermoplastic resin having a deflection temperature under load of lower than 75° C.

The mass ratio of the first thermoplastic resin to the total of the first thermoplastic resin and the second thermoplastic resin is preferably from 0.05 to 0.95.

When the mass ratio of the first thermoplastic resin to the total of the first thermoplastic resin and the second thermoplastic resin is in the range described above, fluctuation of thickness of the inner layer that accompanies flow of the rubber composition of the intermediate layer during vulcanization and adhesiveness to the intermediate layer can be particularly provided in a compatible manner.

The mass ratio of the first thermoplastic resin to the total of the first thermoplastic resin and the second thermoplastic resin may be from 0.05 to 0.95, from 0.10 to 0.90, from 0.20 to 0.80, from 0.30 to 0.70, or from 0.40 to 0.60.

### First Thermoplastic Resin

The first thermoplastic resin is thermoplastic resin having a deflection temperature under load of 75° C. or higher.

The deflection temperature under load can be measured by fixing both end portions in a longitudinal direction of a test piece (length: 80 mm; width: 10 mm; thickness: 4 mm) prepared by using an injection molding machine (Century Innovation Corporation), and increasing the temperature at 2° C./min while a load of 1.8 MPa is applied to a central portion thereof, in accordance with JIS K 7191 “Plastics-Determination of temperature of deflection under load”.

The deflection temperature under load of the first thermoplastic resin may be from 75 to 150° C., from 80 to 140° C., or from 90 to 130° C.

The first thermoplastic resin preferably has an aromatic ring in a main chain. When the thermoplastic resin composition has a deflection temperature under load of 75° C. or higher and has thermoplastic resin having an aromatic ring in a main chain, swelling or change in physical properties of the inner layer when the thermoplastic resin composition is brought into contact with a fuel are less likely to occur.

The aromatic ring preferably has 6 to 10 carbons. That is, the aromatic ring may be, for example, a six-membered ring, an eight-membered ring, or a ten-membered ring.

The first thermoplastic resin is preferably an aromatic polyamide resin.

Examples of the thermoplastic resin having a deflection temperature under load of 75° C. or higher include, but not limited to, nylon MXD6 (MXD6), nylon 6T (Ny6T), nylon 6I (Ny6I), nylon 9T (Ny9T), polybutylene naphthalate (PBN), and polyphenylene sulfide (PPS).

### Second Thermoplastic Resin

The second thermoplastic resin is thermoplastic resin having a deflection temperature under load of lower than 75° C.

The deflection temperature under load of the second thermoplastic resin can be measured by the same method as the measurement of the deflection temperature under load of the first thermoplastic resin.

The deflection temperature under load of the second thermoplastic resin may be 10 or higher and lower than 75° C., from 15 to 70° C., from 30 to 65° C., or from 40 to 60° C.

The second thermoplastic resin is preferably aliphatic polyamide. In a case where the thermoplastic resin composition contains an aliphatic polyamide having a deflection temperature under load of lower than 75° C., rigidity is not excessively high, and occurrence of deformation or crack of the inner layer due to repeated fatigue can be reduced.

Examples of the thermoplastic resin having a deflection temperature under load of lower than 75° C. include, but not limited to, nylon 6 (Ny6), nylon 6.66 (Ny6.66), nylon 6.10 (Ny6.10), nylon 6.12 (Ny6.12), nylon 10.10 (Ny10.10), nylon 11 (Ny11), nylon 12 (Nyl2), nylon 66 (Ny66), polybutylene terephthalate (PBT), and an ethylene vinyl alcohol copolymer (EVOH). The thermoplastic resin having a deflection temperature under load of lower than 75° C. may be a copolymer of these resins.

### Flexible Component

The inner layer preferably further contains rubber and/or elastomer as a flexible component.

Examples of the rubber include, but not limited to, a butyl rubber, an ethylene-propylene-diene rubber, an acrylonitrile-butadiene rubber, a hydrogenated acrylonitrile-butadiene rubber, an acrylic rubber, a fluororubber, an epichlorohydrin rubber, an epoxidized natural rubber, and a mixture of these. The rubber may be vulcanized.

Examples of the elastomer include, but not limited to, polyester elastomer, polyamide elastomer, polystyrene-based elastomer, polyolefin-based elastomer, polyurethane-based elastomer, vinyl chloride-based elastomer, and a modified product of these. From the perspective of preventing swelling by a fuel and from the perspective of affinity for the thermoplastic resin, polyester elastomer, polyamide elastomer, and polystyrene elastomer are particularly preferred.

In a case where the inner layer contains rubber and/or elastomer, the inner layer can have a sea-island structure of the thermoplastic resin composition and the rubber and/or the elastomer.

### Intermediate Layer

The intermediate layer contains a rubber composition containing vulcanized rubber.

Examples of the vulcanized rubber include an acrylonitrile-butadiene rubber (NBR), an acrylonitrile-butadiene rubber (NBR)/polyvinyl chloride (PVC) blend, a chlorosulfonated polyethylene (CSM), a butyl rubber (IIR), and a rubber obtained by vulcanizing a mixture of these.

From the perspective of oil resistance, the acrylonitrile-butadiene rubber can contain from 25 to 50 mass % of acrylonitrile with respect to the entire amount of the acrylonitrile-butadiene rubber. The acrylonitrile-butadiene rubber can contain from 25 to 50 mass %, from 30 to 45 mass %, or from 35 to 40 mass %, of acrylonitrile with respect to the entire amount of the acrylonitrile-butadiene rubber.

The rubber composition can further contain an additive, such as a cross-linking agent, an anti-aging agent, a plasticizer, a processing aid, a cross-linking accelerator aid, a cross-linking accelerator, a reinforcing agent (filler), an antiscorching agent, a peptizing agent, an organic modifier, a softener, and a tackifier.

### Adhesive Layer

The adhesive layer is a layer containing an optional material that can adhere the inner layer and the intermediate layer.

Examples of the adhesive layer include a phenol resin-based adhesive, a urethane resin-based adhesive, an epoxy resin-based adhesive, a resorcinol resin-based adhesive, a urea resin-based adhesive, a melamine resin-based adhesive, and a modified silicone-based adhesive layer.

### Reinforcing Layer

The reinforcing layer may contain, for example, at least one layer of organic fiber layer or metal wire layer.

The positional relationship between the organic fiber layer and the metal wire layer in the reinforcing layer is not particularly limited; however, the organic fiber layer is preferably disposed on the inner layer side and the metal wire layer is preferably disposed on the outer layer side, and the metal wire layer is particularly preferably disposed on the outermost layer side of the reinforcing layer. By this, while expansion and shrinkage of the inner layer during use of the fuel transportation hose are buffered by the organic fiber layer in the inner layer side of the reinforcing layer, high durability can be ensured by the metal wire layer in the outer layer side of the reinforcing layer.

### Organic Fiber Layer

The organic fiber layer may contain at least one type of fiber selected from the group consisting of poly(p-phenylene benzobisoxazole), polyester, polyamide, and polyketone.

Furthermore, the organic fiber layer may be a layer in which yarn made of organic fibers is braided. The organic fiber layer has a braided structure or a spiral structure, and preferably has a braided structure. The braided structure is a structure having a higher stretchability compared to a spiral structure. Thus, the organic fiber layer having a braided structure achieves more flexibility and superior handleability.

### Metal Wire Layer

The metal wire layer may be a layer obtained by braiding wires of metal, such as steel wires, wires of copper and copper alloy, wires of aluminum and aluminum alloy, wires of magnesium alloy, or wires of titanium and titanium alloy. The metal wire layer is particularly preferably a layer in which steel wires are braided. Examples of the steel wires include stainless steel wires or galvanized steel wires.

The metal wire layer may be a layer having a braided structure or a spiral structure, and preferably a layer having a braided structure. The braided structure is a form of braiding having a higher stretchability compared to a spiral structure. Therefore, in a case where the metal wire layer has a braided structure, high durability is achieved while handleability is maintained because of its certain stretchability.

### Outer Layer

The outer layer is typically made of a rubber composition, a thermoplastic elastomer, or a thermoplastic elastomer composition.

Examples of the rubber composition include, but are not limited to, those produced by adding an additive to a rubber. Examples of the additive include a cross-linking agent, an anti-aging agent, a plasticizer, a processing aid, a cross-linking accelerator aid, a cross-linking accelerator, a reinforcing agent (filler), an antiscorching agent, a peptizing agent, an organic modifier, a softener, and a tackifier, and examples of the rubber include an acrylonitrile-butadiene rubber (NBR), an acrylonitrile-butadiene rubber (NBR)/polyvinyl chloride (PVC) blend, a chlorosulfonated polyethylene (CSM), and a butyl rubber (IIR).

Examples of the thermoplastic elastomer include olefin-based thermoplastic elastomer, styrene-based thermoplastic elastomer, polyamide elastomer, polyester elastomer, and polyurethane elastomer.

Examples of thermoplastic elastomer composition include those made of a matrix containing thermoplastic resin and a domain containing rubber. Examples of the thermoplastic resin include polyamide resin, polyester resin, ethylene-vinyl alcohol resin, polyolefin resin, polyketone resin, polyacetal resin, polyphenylene sulfide resin, polyphenylene ether resin, and fluororesin, and examples of the rubber include butyl rubber, modified butyl rubber, olefin-based thermoplastic elastomer, styrene-based thermoplastic elastomer, an ethylene-unsaturated carboxylic acid ester copolymer, polyamide elastomer, polyester elastomer, and polyurethane elastomer.

The thickness of the outer layer is preferably from 0.2 to 5.0 mm, more preferably from 0.2 to 4.0 mm, and even more preferably from 0.2 to 3.0 mm.

### Examples

### Examples 1 to 22 and Comparative Examples 1 to 4 Production of Hose

On a mandrel, first thermoplastic resin, second thermoplastic resin, and elastomer that were dry-blended according to a compounding ratio (mass %) listed in Table 1 were extruded in a thickness (thickness of inner layer) listed in Table 4 by using an extruder, and thus an inner layer was formed.

Next, a rubber composition prepared according to a compounding ratio (parts by mass) listed in Table 2 on an outer side of the inner layer by using a Banbury mixer was extruded in a thickness (thickness of intermediate layer) listed in Table 4, and thus an intermediate layer was formed.

On the outer side of the intermediate layer, a phenol resin-based adhesive was applied, steel wires were braided by using a braiding machine, and thus a reinforcing layer was formed.

A rubber composition prepared according to a compounding ratio (parts by mass) listed in Table 3 on an outer side of the reinforcing layer by using a Banbury mixer was extruded in a thickness of 2.0 mm, and thus an outer layer was formed.

Thereafter, steam vulcanization was performed at 143° C. for 60 minutes, the mandrel was removed, and thus a hose having an inner diameter of 22.5±0.5 mm and an outer diameter of 31.7±0.5 mm was prepared.

Measurement of Deflection Temperature under Load

The deflection temperature under load of each of the first thermoplastic resin and the second thermoplastic resin used in the examples was measured by fixing both end portions of a test piece (length 80 mm×width 10 mm×thickness 4 mm) of the resin prepared by using an injection molding machine (Century Innovation Corporation), and increasing the temperature at 2° C./min while a load of 1.8 MPa was applied to a central portion thereof, in accordance with JIS K 7191 “Plastics-Determination of temperature of deflection under load”.

### Measurement of Degree of Swelling of Inner Layer, Fuel Transmission, and Storage Modulus

### Preparation of Sample

A sheet having a composition same as that of the inner layer was prepared by using first thermoplastic resin, second thermoplastic resin, and elastomer in a compounding ratio (mass %) listed in Table 1 by using a φ40 mm single screw extruder (PLA GIKEN Co., Ltd.) equipped with a T-die with a width of 550 mm. A sheet having an average thickness of 0.15 to 0.20 mm was obtained by setting the temperatures of the cylinder and the die to 240 to 265° C. and setting a cooling roll temperature and a take-up speed to freely chosen conditions.

### Measurement of Degree of Swelling of Inner Layer

The obtained sheet was cut into a size of 1.2 cm length×3.0 cm width, and a specific gravity was calculated by using an automatic specific gravity analyzer in accordance with JIS K 6258-2016 “Volume change measurement”. The sample after the measurement was immersed in a test fuel (isooctane/toluene/ethanol=42.5/42.5/15 vol %) for 7 days, the specific gravity was calculated by the same procedure also for the sample after the immersion, and the degree of swelling was calculated based on the change in before and after the immersion.

### Measurement of Fuel Transmission

20 mL of a test fuel (isooctane/toluene/ethanol=42.5/42.5/15 vol %) was enclosed in an aluminum cup used in JIS Z 0208 “Testing Methods for Determination of the Water Vapour Transmission Rate of Moisture-Proof Packaging Materials”. Then, the obtained sheet was cut in a manner that a transmission surface was in a circle having a diameter of 60 mm, and attached to the aluminum cup. The cup was allowed to stand in an atmosphere of 23° C. with the sheet surface facing downward so that the sheet and the test fuel were always in contact with each other, and the weight of the cup was measured every day. The fuel transmission was calculated from the weight loss on the 7th day.

### Measurement of Storage Modulus

The obtained sheet was cut into a size of 0.5 cm length×10.0 cm width, and a viscoelasticity was measured at a dynamic strain of ±0.1%, a frequency of 20 Hz, and a static strain of 2%, at −30° C.

### Evaluation of Vulcanization Resistance

The prepared hose of each of the examples was cut at a right angle with respect to the longitudinal direction of the hose, and a coefficient of variation (CV value) was determined by measuring thicknesses of the inner layer at 30 points on a periphery using an optical microscope. Variation was determined by performing a similar measurement at 5 points in the longitudinal direction for a hose having a length of 10 cm. Resistance to variation in peripheral thickness caused by variation was evaluated in a manner that, when the CV value of Comparative Example 2 was assigned an index value of 100, less than 80 was “excellent”, 80 or more and less than 90 was “good”, 90 or more and less than 98 was “fair”, and 98 or more was “poor”.

### Evaluation of Adhesiveness Between Inner Layer and Intermediate Layer

A ring-like test piece was prepared by cutting the prepared hose of each of the examples into a predetermined length. End portions of the peeled test piece were fixed to clamps of a tester in a manner that a peeling angle became approximately 90°, and a peel strength between the inner layer and the intermediate layer was measured. When the peel strength of the hose of Comparative Example 1 was assigned an index value of 100, 130 or more was “excellent”, 100 or more and less than 130 was “good”, 80 or more and less than 100 was “fair”, and less than 80 was “poor”.

### Results

Table 1 shows the compositions of the inner layers, Table 2 shows the compositions of the intermediate layers, and Table 3 shows the compositions of the outer layers. Table 4 shows the configuration and test results of the hose of each example. “Ny6.66” in Table 1 means a copolymer of nylon 6 and nylon 66. In addition, similarly, “Ny6.12”, “Ny6.10”, and the like are copolymers of two types of nylons.

TABLE 1-1

| | | | Example | Example | Example | Example |
|---|---|---|---|---|---|---|
| Composition of inner layer | | | 1 | 2 | 3 | 4 |
| Thermoplastic | First | MXD6 (MX nylon S6007, | 30 | 50 | 70 | |
| composition | thermoplastic | Mitsubishi Gas Chemical | | | | |
| | resin | Company, Inc.) | | | | |
| | | Ny9T (Genestar N100A, | | | | |
| | | Kuraray Co., Ltd.) | | | | |
| | | PBN (PELPRENE PB- | | | | 30 |
| | | 560, Toyobo Co., Ltd.) | | | | |
| | | PPS (TORELINA A900, | | | | |
| | | Toray Industries, Inc.) | | | | |
| | Second | Ny6 (UBE Nylon 1022B, | 70 | 50 | 30 | |
| | thermoplastic | Ube Industries, Ltd.) | | | | |
| | resin | Ny6.66 (UBE Nylon | | | | |
| | | 5033B, Ube Industries, | | | | |
| | | Ltd.) | | | | |
| | | Ny6.12 (UBE Nylon | | | | |
| | | 7024B, Ube Industries, | | | | |
| | | Ltd.) | | | | |
| | | Ny6.10 (AMILAN | | | | |
| | | CM2001, Toray Industries, | | | | |
| | | Inc.) | | | | |
| | | Ny10.10 (DS16, Daicel- | | | | |
| | | Evonik Ltd.) | | | | |
| | | Ny11 (BESNOTL, | | | | |
| | | Arkema) | | | | |
| | | Ny12 (UBESTA 3012U, | | | | |
| | | Ube Industries, Ltd.) | | | | |
| | | PBT (TORAYCON 1400S, | | | | 70 |
| | | Toray Industries, Inc.) | | | | |
| | | EVOH (EVAL FP201B, | | | | |
| | | Kuraray Co., Ltd.) | | | | |
| Flexible | Elastomer | TPAE (UBESTA XPA | | | | |
| component | | 9055X1, Ube Industries, | | | | |
| | | Ltd.) | | | | |
| | | TPO (Mah-SEBS Tuftec | | | | |
| | | M1943, Asahi Kasei | | | | |
| | | Corporation) | | | | |
| | | TPC (PELPRENE EN- | | | | |
| | | 500, Toyobo Co., Ltd.) | | | | |

| | | | | |
|---|---|---|---|---|
| Total | 100 | 100 | 100 | 100 |

TABLE 1-2

| | | | Example | Example | Example | Example |
|---|---|---|---|---|---|---|
| Composition of inner layer | | | 5 | 6 | 7 | 8 |
| Thermoplastic | First | MXD6 (MX nylon S6007, | | 30 | | 30 |
| composition | thermoplastic | Mitsubishi Gas Chemical | | | | |
| | resin | Company, Inc.) | | | | |
| | | Ny9T (Genestar N100A, | | | | |
| | | Kuraray Co., Ltd.) | | | | |
| | | PBN (PELPRENE PB- | 30 | | | |
| | | 560, Toyobo Co., Ltd.) | | | | |
| | | PPS (TORELINA A900, | | | 30 | |
| | | Toray Industries, Inc.) | | | | |
| | Second | Ny6 (UBE Nylon 1022B, | | | | |
| | thermoplastic | Ube Industries, Ltd.) | | | | |
| | resin | Ny6.66 (UBE Nylon | | | | 70 |
| | | 5033B, Ube Industries, | | | | |
| | | Ltd.) | | | | |
| | | Ny6.12 (UBE Nylon | | | | |
| | | 7024B, Ube Industries, | | | | |
| | | Ltd.) | | | | |
| | | Ny6.10 (AMILAN | | | | |
| | | CM2001, Toray Industries, | | | | |
| | | Inc.) | | | | |
| | | Ny10.10 (DS16, Daicel- | | | | |
| | | Evonik Ltd.) | | | | |
| | | Ny11 (BESNOTL, | | | | |
| | | Arkema) | | | | |
| | | Ny12 (UBESTA 3012U, | | | 70 | |
| | | Ube Industries, Ltd.) | | | | |
| | | PBT (TORAYCON 1400S, | | | | |
| | | Toray Industries, Inc.) | | | | |
| | | EVOH (EVAL FP201B, | 70 | 70 | | |
| | | Kuraray Co., Ltd.) | | | | |
| Flexible | Elastomer | TPAE (UBESTA XPA | | | | |
| component | | 9055X1, Ube Industries, | | | | |
| | | Ltd.) | | | | |
| | | TPO (Mah-SEBS Tuftec | | | | |
| | | M1943, Asahi Kasei | | | | |
| | | Corporation) | | | | |
| | | TPC (PELPRENE EN- | | | | |
| | | 500, Toyobo Co., Ltd.) | | | | |

| | | |
|---|---|---|
| Total | 100 | 100 |

TABLE 1-3

| | | | Example | Example | Example | Example |
|---|---|---|---|---|---|---|
| Composition of inner layer | | | 9 | 10 | 11 | 12 |
| Thermoplastic | First | MXD6 (MX nylon S6007, | 30 | 30 | 30 | 30 |
| composition | thermoplastic | Mitsubishi Gas Chemical | | | | |
| | resin | Company, Inc.) | | | | |
| | | Ny9T (Genestar N100A, | | | | |
| | | Kuraray Co., Ltd.) | | | | |
| | | PBN (PELPRENE PB- | | | | |
| | | 560, Toyobo Co., Ltd.) | | | | |
| | | PPS (TORELINA A900, | | | | |
| | | Toray Industries, Inc.) | | | | |
| | Second | Ny6 (UBE Nylon 1022B, | | | | |
| | thermoplastic | Ube Industries, Ltd.) | | | | |
| | resin | Ny6.66 (UBE Nylon | | | | |
| | | 5033B, Ube Industries, | | | | |
| | | Ltd.) | | | | |
| | | Ny6.12 (UBE Nylon | 70 | | | |
| | | 7024B, Ube Industries, | | | | |
| | | Ltd.) | | | | |
| | | Ny6.10 (AMILAN | | 70 | | |
| | | CM2001, Toray Industries, | | | | |
| | | Inc.) | | | | |
| | | Ny10.10 (DS16, Daicel- | | | 70 | |
| | | Evonik Ltd.) | | | | |
| | | Ny11 (BESNOTL, | | | | 70 |
| | | Arkema) | | | | |
| | | Ny12 (UBESTA 3012U, | | | | |
| | | Ube Industries, Ltd.) | | | | |
| | | PBT (TORAYCON 1400S, | | | | |
| | | Toray Industries, Inc.) | | | | |
| | | EVOH (EVAL FP201B, | | | | |
| | | Kuraray Co., Ltd.) | | | | |
| Flexible | Elastomer | TPAE (UBESTA XPA | | | | |
| component | | 9055X1, Ube Industries, | | | | |
| | | Ltd.) | | | | |
| | | TPO (Mah-SEBS Tuftec | | | | |
| | | M1943, Asahi Kasei | | | | |
| | | Corporation) | | | | |
| | | TPC (PELPRENE EN- | | | | |
| | | 500, Toyobo Co., Ltd.) | | | | |

| | | |
|---|---|---|
| Total | 100 | 100 |

TABLE 1-4

| | | | Example | Example | Example |
|---|---|---|---|---|---|
| Composition of inner layer | | | 13 | 14 | 15 |
| Thermoplastic | First | MXD6 (MX nylon S6007, | 30 | | |
| composition | thermoplastic | Mitsubishi Gas Chemical | | | |
| | resin | Company, Inc.) | | | |
| | | Ny9T (Genestar N100A, | | 30 | |
| | | Kuraray Co., Ltd.) | | | |
| | | PBN (PELPRENE PB- | | | 30 |
| | | 560, Toyobo Co., Ltd.) | | | |
| | | PPS (TORELINA A900, | | | |
| | | Toray Industries, Inc.) | | | |
| | Second | Ny6 (UBE Nylon 1022B, | | 70 | 70 |
| | thermoplastic | Ube Industries, Ltd.) | | | |
| | resin | Ny6.66 (UBE Nylon | | | |
| | | 5033B, Ube Industries, | | | |
| | | Ltd.) | | | |
| | | Ny6.12 (UBE Nylon | | | |
| | | 7024B, Ube Industries, | | | |
| | | Ltd.) | | | |
| | | Ny6.10 (AMILAN | | | |
| | | CM2001, Toray Industries, | | | |
| | | Inc.) | | | |
| | | Ny10.10 (DS16, Daicel- | | | |
| | | Evonik Ltd.) | | | |
| | | Ny11 (BESNOTL, | | | |
| | | Arkema) | | | |
| | | Ny12 (UBESTA 3012U, | 70 | | |
| | | Ube Industries, Ltd.) | | | |
| | | PBT (TORAYCON 1400S, | | | |
| | | Toray Industries, Inc.) | | | |
| | | EVOH (EVAL FP201B, | | | |
| | | Kuraray Co., Ltd.) | | | |
| Flexible | Elastomer | TPAE (UBESTA XPA | | | |
| component | | 9055X1, Ube Industries, | | | |
| | | Ltd.) | | | |
| | | TPO (Mah-SEBS Tuftec | | | |
| | | M1943, Asahi Kasei | | | |
| | | Corporation) | | | |
| | | TPC (PELPRENE EN- | | | |
| | | 500, Toyobo Co., Ltd.) | | | |

| | | | |
|---|---|---|---|
| Total | 100 | 100 | 100 |

TABLE 1-5

| | | | Example | Example | Example | Example |
|---|---|---|---|---|---|---|
| Composition of inner layer | | | 16 | 17 | 18 | 19 |
| Thermoplastic | First | MXD6 (MX nylon S6007, | | 30 | 30 | 21 |
| composition | thermoplastic | Mitsubishi Gas Chemical | | | | |
| | resin | Company, Inc.) | | | | |
| | | Ny9T (Genestar N100A, | | | | |
| | | Kuraray Co., Ltd.) | | | | |
| | | PBN (PELPRENE PB- | | | | |
| | | 560, Toyobo Co., Ltd.) | | | | |
| | | PPS (TORELINA A900, | 30 | | | |
| | | Toray Industries, Inc.) | | | | |
| | Second | Ny6 (UBE Nylon 1022B, | 70 | 70 | 70 | 49 |
| | thermoplastic | Ube Industries, Ltd.) | | | | |
| | resin | Ny6.66 (UBE Nylon | | | | |
| | | 5033B, Ube Industries, | | | | |
| | | Ltd.) | | | | |
| | | Ny6.12 (UBE Nylon | | | | |
| | | 7024B, Ube Industries, | | | | |
| | | Ltd.) | | | | |
| | | Ny6.10 (AMILAN | | | | |
| | | CM2001, Toray Industries, | | | | |
| | | Inc.) | | | | |
| | | Ny10.10 (DS16, Daicel- | | | | |
| | | Evonik Ltd.) | | | | |
| | | Ny11 (BESNOTL, | | | | |
| | | Arkema) | | | | |
| | | Ny12 (UBESTA 3012U, | | | | |
| | | Ube Industries, Ltd.) | | | | |
| | | PBT (TORAYCON 1400S, | | | | |
| | | Toray Industries, Inc.) | | | | |
| | | EVOH (EVAL FP201B, | | | | |
| | | Kuraray Co., Ltd.) | | | | |
| Flexible | Elastomer | TPAE (UBESTA XPA | | | | 30 |
| component | | 9055X1, Ube Industries, | | | | |
| | | Ltd.) | | | | |
| | | TPO (Mah-SEBS Tuftec | | | | |
| | | M1943, Asahi Kasei | | | | |
| | | Corporation) | | | | |
| | | TPC (PELPRENE EN- | | | | |
| | | 500, Toyobo Co., Ltd.) | | | | |

| | | | | |
|---|---|---|---|---|
| Total | 100 | 100 | 100 | 100 |

TABLE 1-6

| | | | Example | Example | Example | Comparative |
|---|---|---|---|---|---|---|
| Composition of inner layer | | | 20 | 21 | 22 | Example 1 |
| Thermoplastic | First | MXD6 (MX nylon S6007, | 21 | 15 | 21 | |
| composition | thermoplastic | Mitsubishi Gas Chemical | | | | |
| | resin | Company, Inc.) | | | | |
| | | Ny9T (Genestar N100A, | | | | |
| | | Kuraray Co., Ltd.) | | | | |
| | | PBN (PELPRENE PB- | | | | |
| | | 560, Toyobo Co., Ltd.) | | | | |
| | | PPS (TORELINA A900, | | | | |
| | | Toray Industries, Inc.) | | | | |
| | Second | Ny6 (UBE Nylon 1022B, | 49 | 35 | 49 | 100 |
| | thermoplastic | Ube Industries, Ltd.) | | | | |
| | resin | Ny6.66 (UBE Nylon | | | | |
| | | 5033B, Ube Industries, | | | | |
| | | Ltd.) | | | | |
| | | Ny6.12 (UBE Nylon | | | | |
| | | 7024B, Ube Industries, | | | | |
| | | Ltd.) | | | | |
| | | Ny6.10 (AMILAN | | | | |
| | | CM2001, Toray Industries, | | | | |
| | | Inc.) | | | | |
| | | Ny10.10 (DS16, Daicel- | | | | |
| | | Evonik Ltd.) | | | | |
| | | Ny11 (BESNOTL, | | | | |
| | | Arkema) | | | | |
| | | Ny12 (UBESTA 3012U, | | | | |
| | | Ube Industries, Ltd.) | | | | |
| | | PBT (TORAYCON 1400S, | | | | |
| | | Toray Industries, Inc.) | | | | |
| | | EVOH (EVAL FP201B, | | | | |
| | | Kuraray Co., Ltd.) | | | | |
| Flexible | Elastomer | TPAE (UBESTA XPA | | | | |
| component | | 9055X1, Ube Industries, | | | | |
| | | Ltd.) | | | | |
| | | TPO (Mah-SEBS Tuftec | 30 | 50 | | |
| | | M1943, Asahi Kasei | | | | |
| | | Corporation) | | | | |
| | | TPC (PELPRENE EN- | | | 30 | |
| | | 500, Toyobo Co., Ltd.) | | | | |

| | | | | |
|---|---|---|---|---|
| Total | 100 | 100 | 100 | 100 |

TABLE 1-7

| | | | Comparative | Comparative | Comparative |
|---|---|---|---|---|---|
| Composition of inner layer | | | Example 2 | Example 3 | Example 4 |
| Thermoplastic | First | MXD6 (MX nylon | 100 | | 70 |
| composition | thermoplastic | S6007, Mitsubishi Gas | | | |
| | resin | Chemical Company, Inc.) | | | |
| | | Ny9T (Genestar N100A, | | | 30 |
| | | Kuraray Co., Ltd.) | | | |
| | | PBN (PELPRENE PB- | | | |
| | | 560, Toyobo Co., Ltd.) | | | |
| | | PPS (TORELINA A900, | | | |
| | | Toray Industries, Inc.) | | | |
| | Second | Ny6 (UBE Nylon 1022B, | | 70 | |
| | thermoplastic | Ube Industries, Ltd.) | | | |
| | resin | Ny6.66 (UBE Nylon | | | |
| | | 5033B, Ube Industries, | | | |
| | | Ltd.) | | | |
| | | Ny6.12 (UBE Nylon | | 30 | |
| | | 7024B, Ube Industries, | | | |
| | | Ltd.) | | | |
| | | Ny6.10 (AMILAN | | | |
| | | CM2001, Toray | | | |
| | | Industries, Inc.) | | | |
| | | Ny10.10 (DS16, Daicel- | | | |
| | | Evonik Ltd.) | | | |
| | | Ny11 (BESNOTL, | | | |
| | | Arkema) | | | |
| | | Ny12 (UBESTA 3012U, | | | |
| | | Ube Industries, Ltd.) | | | |
| | | PBT (TORAYCON | | | |
| | | 1400S, Toray Industries, | | | |
| | | Inc.) | | | |
| | | EVOH (EVAL FP201B, | | | |
| | | Kuraray Co., Ltd.) | | | |
| Flexible | Elastomer | TPAE (UBESTA XPA | | | |
| component | | 9055X1, Ube Industries, | | | |
| | | Ltd.) | | | |
| | | TPO (Mah-SEBS Tuftec | | | |
| | | M1943, Asahi Kasei | | | |
| | | Corporation) | | | |
| | | TPC (PELPRENE EN- | | | |
| | | 500, Toyobo Co., Ltd.) | | | |

| | | | |
|---|---|---|---|
| Total | 100 | 100 | 100 |

TABLE 2

| Composition of | |
|---|---|
| intermediate layer | Parts by mass |
| NBR | 100.0 |
| Carbon black | 100.0 |
| Sulfur | 1.5 |
| Vulcanization | 1.0 |
| accelerator | |
| Anti-aging agent | 1.0 |
| Zinc oxide | 5.0 |
| Stearic acid | 2.0 |
| Plasticizer | 6.0 |
| Total | 216.5 |

TABLE 3

| Composition of | |
|---|---|
| outer layer | Parts by mass |
| NBR | 100.0 |
| Carbon black | 90.0 |
| Sulfur | 1.5 |
| Vulcanization | 1.0 |
| accelerator | |
| Anti-aging agent | 1.0 |
| Zinc oxide | 5.0 |
| Stearic acid | 2.0 |
| Plasticizer | 6.0 |
| Total | 206.5 |

TABLE 4-1

| Examples | | Example 1 | Example 2 | Example 3 | Example 4 |
|---|---|---|---|---|---|
| Conditions | Deflection temperature under load of | 90 | 90 | 90 | 77 |
| | first thermoplastic resin (° C.) | | | | |
| | Deflection temperature under load of | 60 | 60 | 60 | 58 |
| | second thermoplastic resin (° C.) | | | | |
| | Use of aromatic polyamide resin as | Yes | Yes | Yes | No |
| | first thermoplastic resin | | | | |
| | Use of aliphatic polyamide resin as | Yes | Yes | Yes | No |
| | second thermoplastic resin | | | | |
| | Free sulfur component content of | 0.1 | 0.1 | 0.1 | 0.2 |
| | inner layer (%) | | | | |
| | Thickness of inner layer (mm) | 0.15 | 0.15 | 0.15 | 0.15 |
| | Thickness of intermediate layer (mm) | 2.65 | 2.65 | 2.65 | 2.65 |
| | Ratio of thickness of inner layer to | 0.06 | 0.06 | 0.06 | 0.06 |
| | thickness of intermediate layer | | | | |
| | Degree of swelling of inner layer (%) | 6.1 | 4.8 | 2.8 | 6.5 |
| | Fuel transmission of inner layer | 0.10 | 0.10 | 0.10 | 2.00 |
| | (mm · mg/24 h · cm²) | | | | |
| | Storage modulus E at −30° C. (MPa) | 3100 | 3720 | 4340 | 3000 |
| | Presence of flexible component | No | No | No | No |
| | AN amount in NBR of intermediate | 43 | 43 | 43 | 43 |
| | layer (mass %) | | | | |
| Results | Vulcanization resistance | Excellent | Excellent | Excellent | Fair |
| | Adhesiveness between inner layer and | Excellent | Good | Fair | Fair |
| | intermediate layer | | | | |

TABLE 4-2

| Examples | | Example 5 | Example 6 | Example 7 | Example 8 |
|---|---|---|---|---|---|
| Conditions | Deflection temperature under load of | 77 | 90 | 112 | 90 |
| | first thermoplastic resin (° C.) | | | | |
| | Deflection temperature under load of | 69 | 69 | 48 | 60 |
| | second thermoplastic resin (° C.) | | | | |
| | Use of aromatic polyamide resin as | No | Yes | No | Yes |
| | first thermoplastic resin | | | | |
| | Use of aliphatic polyamide resin as | No | No | Yes | Yes |
| | second thermoplastic resin | | | | |
| | Free sulfur component content of | 0.2 | 0.1 | 0.3 | 0.2 |
| | inner layer (%) | | | | |
| | Thickness of inner layer (mm) | 0.15 | 0.15 | 0.15 | 0.15 |
| | Thickness of intermediate layer (mm) | 2.65 | 2.65 | 2.65 | 2.65 |
| | Ratio of thickness of inner layer to | 0.06 | 0.06 | 0.06 | 0.06 |
| | thickness of intermediate layer | | | | |
| | Degree of swelling of inner layer (%) | 5.5 | 5.0 | 10.4 | 6.2 |
| | Fuel transmission of inner layer | 0.50 | 0.10 | 0.80 | 0.10 |
| | (mm · mg/24 h · cm²) | | | | |
| | Storage modulus E at −30° C. (MPa) | 4000 | 4200 | 4000 | 2900 |
| | Presence of flexible component | No | No | No | No |
| | AN amount in NBR of intermediate | 43 | 43 | 43 | 43 |
| | layer (mass %) | | | | |
| Results | Vulcanization resistance | Fair | Good | Excellent | Excellent |
| | Adhesiveness between inner layer and | Fair | Excellent | Fair | Excellent |
| | intermediate layer | | | | |

TABLE 4-3

| Examples | | Example 9 | Example 10 | Example 11 | Example 12 |
|---|---|---|---|---|---|
| Conditions | Deflection temperature under load of | 90 | 90 | 90 | 90 |
| | first thermoplastic resin (° C.) | | | | |
| | Deflection temperature under load of | 50 | 50 | 40 | 42 |
| | second thermoplastic resin (° C.) | | | | |
| | Use of aromatic polyamide resin as | Yes | Yes | Yes | Yes |
| | first thermoplastic resin | | | | |
| | Use of aliphatic polyamide resin as | Yes | Yes | Yes | Yes |
| | second thermoplastic resin | | | | |
| | Free sulfur component content of | 0.3 | 0.3 | 0.3 | 0.3 |
| | inner layer (%) | | | | |
| | Thickness of inner layer (mm) | 0.15 | 0.15 | 0.15 | 0.15 |
| | Thickness of intermediate layer | 2.65 | 2.65 | 2.65 | 2.65 |
| | (mm) | | | | |
| | Ratio of thickness of inner layer to | 0.06 | 0.06 | 0.06 | 0.06 |
| | thickness of intermediate layer | | | | |
| | Degree of swelling of inner layer | 11.4 | 10.0 | 10.0 | 11.4 |
| | (%) | | | | |
| | Fuel transmission of inner layer | 0.50 | 0.50 | 0.70 | 0.80 |
| | (mm · mg/24 h · cm²) | | | | |
| | Storage modulus E at −30° C. (MPa) | 2680 | 2700 | 2600 | 2500 |
| | Presence of flexible component | No | No | No | No |
| | AN amount in NBR of intermediate | 43 | 43 | 43 | 43 |
| | layer (mass %) | | | | |
| Results | Vulcanization resistance | Excellent | Excellent | Excellent | Good |
| | Adhesiveness between inner layer | Excellent | Excellent | Good | Excellent |
| | and intermediate layer | | | | |

TABLE 4-4

| Examples | | Example 13 | Example 14 | Example 15 |
|---|---|---|---|---|
| Conditions | Deflection temperature under load of | 90 | 125 | 77 |
| | first thermoplastic resin (° C.) | | | |
| | Deflection temperature under load of | 48 | 60 | 60 |
| | second thermoplastic resin (° C.) | | | |
| | Use of aromatic polyamide resin as | Yes | Yes | No |
| | first thermoplastic resin | | | |
| | Use of aliphatic polyamide resin as | Yes | Yes | Yes |
| | second thermoplastic resin | | | |
| | Free sulfur component content of | 0.3 | 0.1 | 0.2 |
| | inner layer (%) | | | |
| | Thickness of inner layer (mm) | 0.15 | 0.15 | 0.15 |
| | Thickness of intermediate layer | 2.65 | 2.65 | 2.65 |
| | (mm) | | | |
| | Ratio of thickness of inner layer to | 0.06 | 0.06 | 0.06 |
| | thickness of intermediate layer | | | |
| | Degree of swelling of inner layer | 11.4 | 5.5 | 6.8 |
| | (%) | | | |
| | Fuel transmission of inner layer | 0.80 | 0.10 | 1.60 |
| | (mm · mg/24 h · cm²) | | | |
| | Storage modulus E at −30° C. (MPa) | 2600 | 3500 | 3400 |
| | Presence of flexible component | No | No | No |
| | AN amount in NBR of intermediate | 43 | 43 | 43 |
| | layer (mass %) | | | |
| Results | Vulcanization resistance | Good | Excellent | Excellent |
| | Adhesiveness between inner layer | Excellent | Excellent | Good |
| | and intermediate layer | | | |

TABLE 4-5

| Examples | | Example 16 | Example 17 | Example 18 | Example 19 |
|---|---|---|---|---|---|
| Conditions | Deflection temperature under load | 112 | 90 | 90 | 90 |
| | of first thermoplastic resin (° C.) | | | | |
| | Deflection temperature under load | 60 | 60 | 60 | 60 |
| | of second thermoplastic resin (° C.) | | | | |
| | Use of aromatic polyamide resin | No | Yes | Yes | Yes |
| | as first thermoplastic resin | | | | |
| | Use of aliphatic polyamide resin | Yes | Yes | Yes | Yes |
| | as second thermoplastic resin | | | | |
| | Free sulfur component content of | 0.2 | 0.2 | 0.2 | 0.2 |
| | inner layer (%) | | | | |
| | Thickness of inner layer (mm) | 0.15 | 0.05 | 0.40 | 0.35 |
| | Thickness of intermediate layer | 2.65 | 4.00 | 0.30 | 0.40 |
| | (mm) | | | | |
| | Ratio of thickness of inner layer | 0.06 | 0.013 | 1.33 | 0.88 |
| | to thickness of intermediate layer | | | | |
| | Degree of swelling of inner layer | 5.8 | 6.1 | 6.1 | 11.4 |
| | (%) | | | | |
| | Fuel transmission of inner layer | 0.20 | 0.10 | 0.10 | 3.80 |
| | (mm · mg/24 h · cm²) | | | | |
| | Storage modulus E at −30° C. | 3500 | 3090 | 3090 | 2500 |
| | (MPa) | | | | |
| | Presence of flexible component | No | No | No | Yes |
| | AN amount in NBR of | 43 | 43 | 43 | 43 |
| | intermediate layer (mass %) | | | | |
| Results | Vulcanization resistance | Excellent | Excellent | Excellent | Excellent |
| | Adhesiveness between inner layer | Good | Excellent | Excellent | Excellent |
| | and intermediate layer | | | | |

TABLE 4-6

| | | Examples | | | |
|---|---|---|---|---|---|
| | | Example | Example | Example | Comparative |
| | | 20 | 21 | 22 | Example 1 |
| Conditions | Deflection temperature under load | 90 | 90 | 90 | 60 |
| | of first thermoplastic resin (° C.) | | | | |
| | Deflection temperature under load | 60 | 60 | 60 | — |
| | of second thermoplastic resin (° C.) | | | | |
| | Use of aromatic polyamide resin | Yes | Yes | Yes | Yes |
| | as first thermoplastic resin | | | | |
| | Use of aliphatic polyamide resin | Yes | Yes | Yes | No |
| | as second thermoplastic resin | | | | |
| | Free sulfur component content of | 0.2 | 0.2 | 0.2 | — |
| | inner layer (%) | | | | |
| | Thickness of inner layer (mm) | 0.15 | 0.15 | 0.15 | 0.15 |
| | Thickness of intermediate layer | 2.65 | 2.65 | 2.65 | 2.65 |
| | (mm) | | | | |
| | Ratio of thickness of inner layer | 0.06 | 0.06 | 0.06 | 0.06 |
| | to thickness of intermediate layer | | | | |
| | Degree of swelling of inner layer | 29.6 | 35.5 | 15.9 | 8.2 |
| | (%) | | | | |
| | Fuel transmission of inner layer | 4.20 | 5.00 | 1.20 | 0.30 |
| | (mm · mg/24 h · cm²) | | | | |
| | Storage modulus E at −30° C. | 2200 | 1700 | 2100 | 2800 |
| | (MPa) | | | | |
| | Presence of flexible component | Yes | Yes | Yes | No |
| | AN amount in NBR of | 43 | 43 | 43 | 43 |
| | intermediate layer (mass %) | | | | |
| Results | Vulcanization resistance | Excellent | Excellent | Excellent | Poor |
| | Adhesiveness between inner layer | Excellent | Excellent | Excellent | Excellent |
| | and intermediate layer | | | | |

TABLE 4-7

| | | Examples | | |
|---|---|---|---|---|
| | | Comparative | Comparative | Comparative |
| | | Example 2 | Example 3 | Example 4 |
| Conditions | Deflection temperature under load | 90 | 50 | 125 |
| | of first thermoplastic resin (° C.) | | | |
| | Deflection temperature under load | — | 60 | 90 |
| | of second thermoplastic resin (° C.) | | | |
| | Use of aromatic polyamide resin as | No | No | Yes |
| | first thermoplastic resin | | | |
| | Use of aliphatic polyamide resin as | Yes | Yes | Yes |
| | second thermoplastic resin | | | |
| | Free sulfur component content of | — | 0.3 | 0.0 |
| | inner layer (%) | | | |
| | Thickness of inner layer (mm) | 0.15 | 0.15 | 0.15 |
| | Thickness of intermediate layer | 2.65 | 2.65 | 2.65 |
| | (mm) | | | |
| | Ratio of thickness of inner layer to | 0.013 | 0.06 | 0.06 |
| | thickness of intermediate layer | | | |
| | Degree of swelling of inner layer | 1.4 | 10 | 1.0 |
| | (%) | | | |
| | Fuel transmission of inner layer | 0.02 | 0.40 | 0.01 |
| | (mm · mg/24 h · cm²) | | | |
| | Storage modulus E at −30° C. (MPa) | 4000 | 2900 | 4500 |
| | Presence of flexible component | No | No | No |
| | AN amount in NBR of | 43 | 43 | 43 |
| | intermediate layer (mass %) | | | |
| Results | Vulcanization resistance | Excellent | Poor | Excellent |
| | Adhesiveness between inner layer | Poor | Excellent | Poor |
| | and intermediate layer | | | |

As shown in Table 4, each of the hoses of Examples 1 to 22 provided the Vulcanization resistance and the adhesiveness between the inner layer and the intermediate layer in a compatible manner. On the other hand, Comparative Examples 1 to 4 did not provide the vulcanization resistance and the adhesiveness between the inner layer and the intermediate layer in a compatible manner.

1. A fuel transportation hose comprising an inner layer, an intermediate layer, a reinforcing layer, and an outer layer laminated in this order,
the inner layer containing a thermoplastic resin composition containing first thermoplastic resin having a deflection temperature under load of 75° C. or higher and second thermoplastic resin having a deflection temperature under load of lower than 75° C.,
the intermediate layer containing a rubber composition containing vulcanized rubber, and
the inner layer and the intermediate layer-) being bonded in a direct manner or via an adhesive layer.

2. The fuel transportation hose according to claim 1, wherein a ratio of a mass of the first thermoplastic resin to a total mass of the first thermoplastic resin and the second thermoplastic resin is from 0.05 to 0.95.

3. The fuel transportation hose according to claim 1, wherein the first thermoplastic resin has an aromatic ring in a main chain.

4. The fuel transportation hose according to claim 3, wherein the aromatic ring has 6 to 10 carbons.

5. The fuel transportation hose according to claim 1, wherein the first thermoplastic resin is aromatic polyamide resin.

6. The fuel transportation hose according to claim 1, wherein the second thermoplastic resin is aliphatic polyamide.

7. The fuel transportation hose according to claim 1, wherein the inner layer has a content of a free sulfur component with respect to an amount of the inner layer of 1.0 mass % or less or contains no free sulfur component.

8. The fuel transportation hose according to claim 1, wherein a ratio of a thickness of the inner layer to a thickness of the intermediate layer is from 0.01 to 2.00.

9. The fuel transportation hose according to claim 1, wherein
the inner layer has a degree of swelling after 7 days of immersion in a fuel at a temperature of 23° C. of 35.0% or less, and
the fuel contains 42.5 vol % of isooctane, 42.5 vol % of toluene, and 15 vol % of ethanol with respect to an entire amount of the fuel.

10. The fuel transportation hose according to claim 1, wherein
the inner layer has a fuel transmission after 7 days of immersion in a fuel at a temperature of 23° C. of 5.00 mg·mm/24 h·cm² or less, and
the fuel contains 42.5 vol % of isooctane, 42.5 vol % of toluene, and 15 vol % of ethanol with respect to an entire amount of the fuel.

11. The fuel transportation hose according to claim 1, wherein the inner layer has a storage modulus E at −30° C. of 1500 to 3500 MPa.

12. The fuel transportation hose according to claim 1, wherein the inner layer further contains rubber and/or elastomer.

13. The fuel transportation hose according to claim 12, wherein the elastomer is polyester elastomer, polyamide elastomer, or modified styrene-based elastomer.

14. The fuel transportation hose according to claim 12, wherein the inner layer has a sea-island structure of the thermoplastic resin composition and the rubber and/or the elastomer.

15. The fuel transportation hose according to claim 1, wherein
the vulcanized rubber is rubber with acrylonitrile-butadiene rubber vulcanized, and
the acrylonitrile-butadiene rubber contains 25 to 50 mass % of acrylonitrile with respect to an entire amount of the acrylonitrile-butadiene rubber.
